(19) United States
(12) Patent Application Publication
(10) Pub. No.: US 2016/0129859 A1
(43) Pub. Date: May 12, 2016

(54) UNIVERSAL APPARATUS FOR SWITCHES OF DEVICE IN VEHICLE

(71) Applicants: Hyundai Motor Company, Seoul (KR); Kia Motors Corporation, Seoul (KR)

(72) Inventors: Young Il LEE, Gunpo-si (KR); Jung Hyeon BAE, Goyang-si (KR)

(21) Appl. No.: 14/696,016

(22) Filed: Apr. 24, 2015

(30) Foreign Application Priority Data
Nov. 12, 2014 (KR) 10-2014-0157365

(51) Int. Cl. B60R 16/023

(52) U.S. Cl. CPC B60R 16/023

(57) ABSTRACT

A universal apparatus for switches includes: an input module including at least one first switch which generates a control signal for performing at least one function included in a vehicle; a communication module transmitting the control signal; and a control module performing the at least one function corresponding to the control signal generated by the first switch and transmitted by the communication module.

### CROSS-REFERENCE TO RELATED APPLICATION

This application is based on and claims the benefit of priority to Korean Patent Application No. 10-2014-0157365, filed on Nov. 12, 2014 in the Korean Intellectual Property Office, the disclosure of which is incorporated herein in its entirety by reference.

### TECHNICAL FIELD

The present disclosure relates to a universal apparatus for switches of a device in a vehicle, and more particularly, to a universal apparatus for switches of a device in a vehicle capable of simplifying operation switches by integrating the operation switches of various devices for a vehicle control which are included in a front console in the vehicle.

### BACKGROUND

Various devices are equipped in a vehicle. To operate the devices, operation switches 10 corresponding to each device are equipped in a front console to operate the devices as illustrated in FIG. 1. Further, more devices are equipped in the vehicle and the number of operation switches is increased correspondingly.

As such, the plurality of operation switches equipped in the vehicle are separately provided with connection lines for each operation switch, and therefore, configuration costs of the connection lines may be increased due to an increase in wirings in the front console and a space inside the front console may be insufficient.

### SUMMARY

The present disclosure has been made to solve the above-mentioned problems occurring in the prior art while advantages achieved by the prior art are maintained intact.

An aspect of the present disclosure provides a universal apparatus for switches of a device in a vehicle capable of preventing costs from rising due to a connection line and solving a space lack in a front console by minimizing the number of connection lines for operation switches for operating various devices in the vehicle.

According to an exemplary embodiment of the present disclosure, a universal apparatus for switches includes: an input module including at least one first switch which generates a control signal for performing at least one function included in a vehicle; a communication module for transmitting the control signal; and a control module for performing the at least one function corresponding to the control signal generated by the first switch and transmitted by the communication module.

The communication module may be configured to perform CAN communication.

The at least one first switch may be formed in a single main body.

The control module may include a unit corresponding to the at least one function to perform the at least one function.

The at least one function may be at least one of an active eco for improving fuel efficiency by controlling an engine, a transmission, and an air conditioner of the vehicle, an idle stop & go of the vehicle, a flex steer for variably selecting a steering wheel steering force to meet driver's inclination, a heated steering wheel, a smart parking assist system, a parking aid system when the vehicle moves backward, a drive mode of the vehicle, an around view monitoring system of the vehicle, and a rear curtain.

The input module may further include a second switch for performing an electronic parking brake (EPB) function.

The second switch may be connected to the control module by a single connection line.

### BRIEF DESCRIPTION OF THE DRAWINGS

The above and other objects, features and advantages of the present disclosure will be more apparent from the following detailed description taken in conjunction with the accompanying drawings, in which:

FIG. 1 is a diagram illustrating a form of an existing front console;

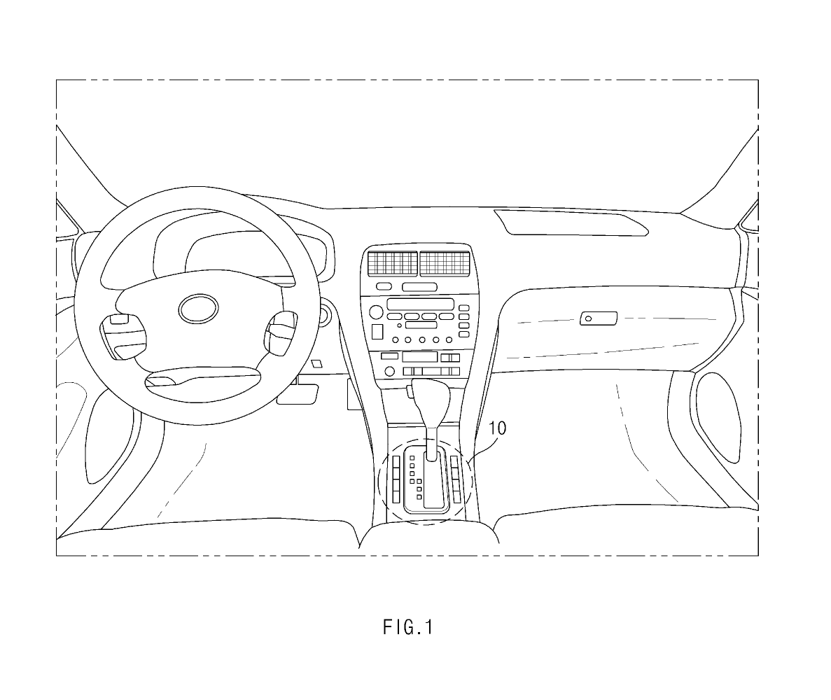

FIG. 2 is a diagram illustrating a main configuration of a universal apparatus for switches according to an exemplary embodiment of the present disclosure;

FIG. 3 is a diagram schematically illustrating a circuit depending on the universal apparatus for switches according to the exemplary embodiment of the present disclosure; and

FIGS. 4A to 4D are a diagram for describing the universal apparatus for switches according to the exemplary embodiment of the present disclosure.

### DETAILED DESCRIPTION

Hereinafter, various exemplary embodiments of the present disclosure will be described with reference to the accompanying drawings. The exemplary embodiments of the present disclosure may be variously changed and variously practiced, but specific exemplary embodiments are illustrated in the accompanying drawings and detailed contents thereof will be described. However, it is to be understood that various exemplary embodiments of the present disclosure are not limited to the specific exemplary embodiments, but include all modifications, equivalents, and substitutions included in the spirit and the scope of the present disclosure. In describing the drawings, like components are denoted by like reference numerals.

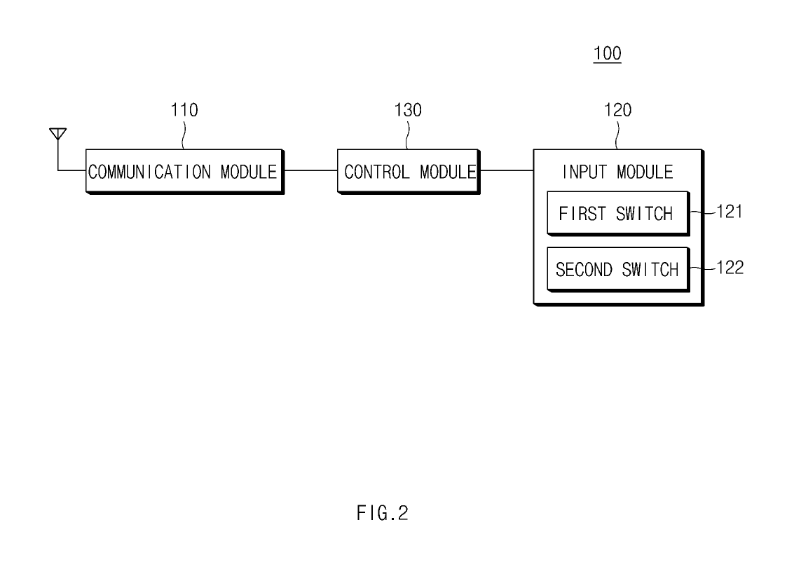

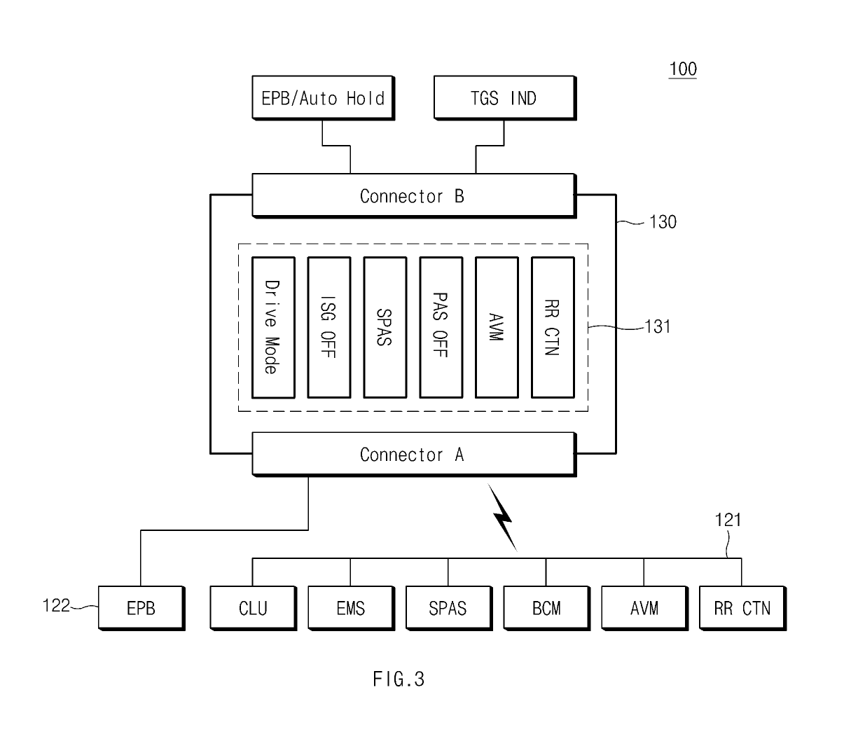

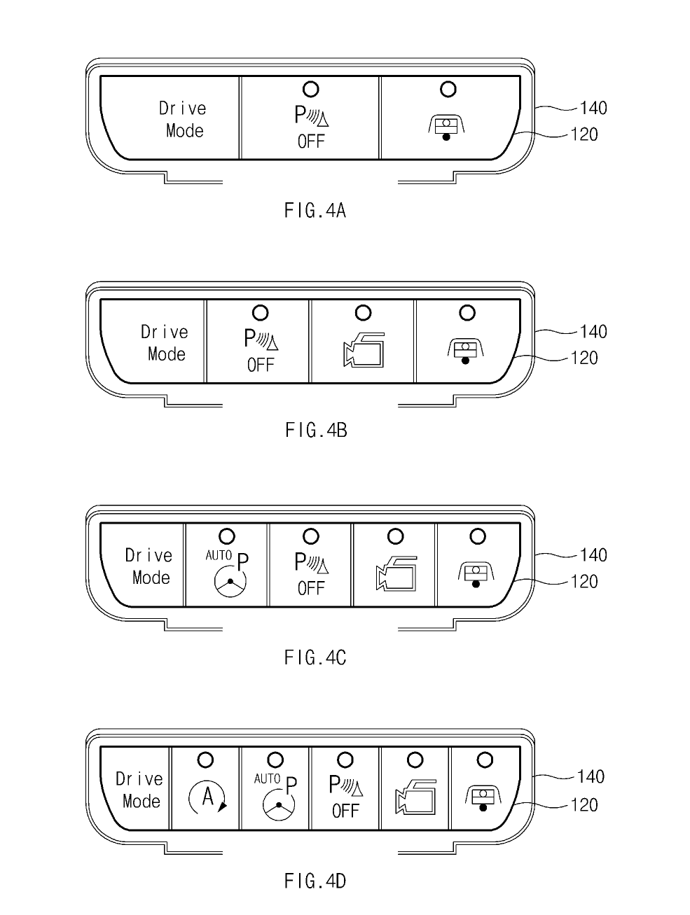

FIG. 2 is a diagram illustrating a main configuration of a universal apparatus for switches according to an exemplary embodiment of the present disclosure. FIG. 3 is a diagram schematically illustrating a circuit depending on the universal apparatus for switches according to the exemplary embodiment of the present disclosure. FIGS. 4A to 4D are diagrams for describing the universal apparatus for switches according to the exemplary embodiment of the present disclosure.

Referring to FIGS. 2 to 4, a universal apparatus 100 for switches according to an exemplary embodiment of the present disclosure may include a communication module 110, an input module 120, and a control module 130.

The communication module 110 may use a vehicle network communication to perform communication between the input module 120 and the control module 130. The vehicle network may include a controller area network (CAN), a local interconnection network (LIN), a FlexRay, a media oriented system transport (MOST), Ethernet, and the like.

The input module 120 may generate a control signal depending on an input from the outside. In particular, the input module 120 may include a first switch 121 and a second switch 122. The first switch 121 may generate the control signal for performing a function provided by a vehicle depending on the input from the outside and provide the generated control signal to the control module 130 through the CAN communication. The second switch 122 may be a switch for performing an electronic parking brake (EPB) function. The second switch 122 may generate the control signal depending on the input from the outside and provide the generated control signal to the control module 130. In this configuration, the second switch 122 and the control module 130 may be connected to each other by one connection line (connector) as illustrated in FIG. 3, without using the CAN communication.

According to the exemplary embodiment of the present disclosure, the input module 120 may include at least one first switch 121 which is positioned in a main body 140 as illustrated in FIGS. 4A to 4D. In this case, the number of first switches 121 which are disposed in the main body 140 may be different depending on a function which is supported in the vehicle and a function corresponding to the first switch 121 which is provided in the main body 140 may be different depending on the desired function which is supported in the vehicle. For example, as illustrated in FIG. 4A, when three first switches 121 are provided in the main body 140, the first switch 121 may be a drive mode of the vehicle and a parking aid system and an around view monitoring (AVN) system when the vehicle moves backward.

By the above configuration, a freedom of design of the input module 120 may be guaranteed. The first switch 121 may be connected to the control module 130 through wireless communication as illustrated in FIG. 3 and therefore the number of connection lines may be more reduced than the related art. In this case, the first switch 121 may be a switch which corresponds to functions which include an active eco for improving fuel efficiency by controlling an engine, a transmission, and an air conditioner, respectively of the vehicle, an idle stop & go of the vehicle, a flex steer for variably selecting a steering wheel steering force to meet driver's inclination, a heated steering wheel, a smart parking assist system, the parking aid system when the vehicle moves backward, the drive mode of the vehicle, the around view monitoring system of the vehicle, and a rear curtain equipped on a rear window of the vehicle to shield sunlight.

The control module 130 may be mounted on a printed circuit board and may activate a unit 131 corresponding to the first switch 121 among the units 131 which are included in the control module 130 depending on the operation of the first switch 121. For example, when receiving the control signal for performing a function of the smart parking assist system among the first switches 121, the control module 130 may activate the unit 131 supporting the function of the smart parking assist system among the units, for example, an SPAS unit. The control module 130 may activate the SPAS unit to perform the function of the smart parking assist system so as to correspond to the control signal.

According to the exemplary embodiment of the present disclosure, as illustrated in FIGS. 4A to 4D, at least one first switch 121 is formed to be integrated in a single main body 140 and the first switch 121 may be connected to the control module 130 through wireless communication to reduce the number of connection lines between the first switch 121 and the control module 130. The universal apparatus 100 for switches may integrate the first switch 121 to share circuits such as a power supply, a ground, and the like.

As described above, according to the exemplary embodiments of the present disclosure, it is possible to prevent costs from rising due to the connection line and solving the space lack in the front console by minimizing the number of connection lines for the operation switches for operating various devices in the vehicle.

The exemplary embodiments of the present disclosure disclosed in the present specification and the accompanying drawings have been provided only as specific examples in order to assist in understanding the present disclosure and do not limit the scope of the present disclosure. Therefore, it is to be understood that in addition to the exemplary embodiments of the present disclosure described herein, all the changed or modified forms derived from the technical spirit of the present disclosure are included in the scope of the present disclosure.

What is claimed is:

1. A universal apparatus for switches, comprising:
an input module including at least one first switch which generates a control signal for performing at least one function included in a vehicle;
a communication module for transmitting the control signal via a vehicle communication network; and
a control module for performing the at least one function corresponding to the control signal generated by the first switch and transmitted by the communication module.

2. The universal apparatus for switches according to claim 1, wherein the vehicle communication network includes at least one of a controller area network (CAN), a local interconnect network (LIN), FlexRay, Ethernet, and a media oriented system transport (MOST).

3. The universal apparatus for switches according to claim 1, wherein the at least one first switch is formed in a single main body.

4. The universal apparatus for switches according to claim 1, wherein the control module includes a unit corresponding to the at least one function to perform the at least one function.

5. The universal apparatus for switches according to claim 4, wherein the at least one function is at least one of an active eco for improving fuel efficiency by controlling an engine, a transmission, and an air conditioner of the vehicle, an idle stop & go of the vehicle, a flex steer for variably selecting a steering wheel steering force to meet driver's inclination, a heated steering wheel, a smart parking assist system, a parking aid system when the vehicle moves backward, a drive mode of the vehicle, an around view monitoring system of the vehicle, and a rear curtain of the vehicle.

6. The universal apparatus for switches according to claim 1, wherein the input module further includes a second switch for performing an electronic parking brake (EPB) function.

7. The universal apparatus for switches according to claim 6, wherein the second switch is connected to the control module by a single connection line.
